(19) United States
(12) Patent Application Publication
(10) Pub. No.: US 2005/0236234 A1
(43) Pub. Date: Oct. 27, 2005

(54) Method and device for testing the functional reliability of parts subject to wear and/or functional parts of a disc brake

(75) Inventors: Willi Ertl, Vilshofen (DE); Wlodzimierz Macke, Olching (DE)

Correspondence Address: CROWELL & MORING LLP;INTELLECTUAL PROPERTY GROUP, P.O. BOX 14300, WASHINGTON, DC, 20044-4300, US

(73) Assignee: Knorr_Bremse Systeme fuer Nutzfahrzeuge GmbH, Muenchen (DE)

(21) Appl. No.: 10/507,634

(22) PCT Filed: Mar. 13, 2003
(86) PCT No.: PCT/EP03/02588

§ 371 Date: Jun. 20, 2005

(30) Foreign Application Priority Data
Mar. 16, 2002 (DE) 102 11 813.2

(51) Int. Cl. F16D 66/00

(52) U.S. Cl. 188/1.11 R

(57) ABSTRACT

The invention relates to a method for testing the functional reliability of parts subject to wear and/or functional parts, whose position can change, or components thereof in a pneumatic or electromechanically actuated disc brake, in particular for a commercial vehicle. According to said method, reflectable signals are emitted by a transmitter to the functional part that is to be tested, the reflected signals are received by the receiver and the actual and desired values are compared and evaluated.

### BACKGROUND AND SUMMARY OF THE INVENTION

The present invention relates to a method of testing the functional reliability of parts subject to wear and/or functional parts, whose position can change, of a disc brake, as well as to a system for implementing the method.

For many different reasons, it is known to continuously monitor the wear condition of a disc brake so that any necessary maintenance takes place at the best possible point in time. In this case, the wear condition of the brake pads and, under certain circumstances, of the brake disc should be diagnosed as precisely as possible.

As a result, it is to be achieved that the maintenance does not take place too early; that is, when the parts subject to wear, such as the brake pads and the brake disc, are still functionally reliable, whereby costs can be optimized.

On the other hand, the maintenance should not be carried out too late; that is, when an acceptable wear has already been exceeded. In this case, the functional reliability of the disc brake would no longer be adequate.

Furthermore, the wear condition of the brake pads or of the brake disc is required as an actuating variable for a frequently used EBS (electronic braking system), so that a precise testing of the functional reliability of the relevant parts is absolutely necessary.

Different methods and systems, respectively, are known for testing the functional reliability of parts subject to wear, whose position can be changed, or components thereof. Such methods and systems, however, are all not suitable for achieving an optimized monitoring of the wear or testing of the functional reliability.

Thus, it is known to carry out a continuous wear indication in a summarizing manner for both brake pads by the use of a potentiometer. A so-called black/white display also has a summarizing effect for both brake pads. Finally, wear clips are used in the prior art, which clips are integrated in the brake pads and permit a final wear indicated individually for each brake pad; thus, no continuous wear indication.

A continuous monitoring of the wear of the two brake pads individually as well as, under certain circumstances, of the brake disc, has not been possible so far. This is required, however, in order to achieve an improvement of vehicle diagnostics; for example, for detecting malfunctioning, such as a non-uniform wear.

A detection of the necessity of exchanging the brake disc cannot be achieved through the use of the known testing methods. This also applies to other functional parts, for example, to detecting disturbances of adjusting functions as carried out by adjusting devices.

It is therefore an object of the present invention to further develop a method of the above-mentioned type such that an optimized testing for functional reliability of parts subject to wear, as well as of functional parts, can be achieved.

This object is achieved by a method of testing the functional reliability of parts subject to wear and/or functional parts, whose position can be changed, of a particularly pneumatically or electromechanically operable disc brake, particularly for a commercial vehicle, wherein signals which can be reflected by a transmitter are sent to the functional part to be tested, the reflected signals are received by a receiver, and the determined actual values are compared with desired values and are analyzed. A system for implementing the method characterized in that a transmitter emitting reflectable signals and a receiver receiving the reflected signals are provided on a disc brake or on component adjacents thereto, which transmitter and receiver are in an operative connection with an electronic analyzing system.

By using reflectable signals, such as ultrasound or laser beams, which are emitted by a transmitter arranged stationarily with respect to the parts subject to wear and the functional parts, position changes, for example, of the parts subject to wear can be determined. The position change in the case of parts subject to wear, for example, of the disc brake or the brake pads, is a result of the wear-caused reduction of their thickness at which the respective effective surface changes in its position, while the deviation from a known position change of functional parts may indicate disturbances.

Such a disturbance-caused deviation of a desired position change can be determined, for example, when testing the sequence of motion of a bridge of a brake application device. The position of the bridge before and after the application of the brake at a defined actuating force, which exists as a parameter, is determined by the transmitter and receiver or an analyzing unit.

The path of the bridge is composed of the release play and an elastic deformation of corresponding brake components (caliper and brake pads), the elastic deformation extending linearly proportional to the actuating force, so that it can be precisely determined.

If the path of the bridge during the actuation of the brake with a certain force exceeds or falls below the computed desired values, this permits the conclusion that the release play is too large or too small, whereby disturbances of the adjusting function can be determined in time. Thus, safety risks leading to an overheating resulting from a play between the brake disc and the brake pads which is too large or from a play which is too small can be avoided.

The above-mentioned use is to be considered as an example, since in this manner the checking of the movement sequences of different relevant parts of the disc brake can be achieved.

For example, if the release play is to be monitored, a testing of the parameters resulting from the comparison between the desired value and the actual value also before and during a braking is contemplated. However, in this case, not every braking operation has to be considered. On the contrary, measurements can take place periodically; for example, a first braking after the engine has been started or, for example, every 30th braking after the engine has been started, at operating the temperature.

Also, when only the thickness of the brake pads and/or of the brake disc is determined, the testing can take place periodically.

The testing of the parts subject to wear and/or the functional parts takes place such that, during the vehicle operation, the transmitter permanently emits a signal which is partially reflected by each existing partition gap or its dimensions. The reflected signals—sound waves in the case of the ultrasonic transmitter—are received by the receiver. On the basis of the different paths covered by the individual reflected signals and the resulting different propagation times situated between the transmitting and receiving points in time, the thickness of the brake pads and of the brake disc is continuously determined by the use of an electronic analyzing system. The desired value is defined by the value which, in practice, is present in the unused, thus new condition, of the brake disc and of the brake pads, respectively.

Depending on the wear of the brake pads or of the brake disc, the propagation time of the reflected signal also changes, wherein comparison with the desired value indicates the reduction of the brake pads or of the brake disc. When a desired-actual value difference is reached or exceeded, an additional indication can take place by which it is pointed out that an exchange of the parts subject to wear is required.

Furthermore, the method according to the invention makes it possible that a non-uniform wear of the parts subject to wear is detected in time. Likewise, information can be obtained, for example, concerning a possible malfunctioning of the brake, for example, caused by a jamming of the caliper guides. For a measuring of the cumulative wear described with respect to the prior art, an additional safety factor covering a possible non-uniform wear has to be factored in for the brake pads, such that the information to exchange the brake pads comes too early when the wear is the uniform. By contrast, the method according to the invention, as mentioned above, offers the possibility of individually determining the wear of each brake pad. In the case of a uniform wear, the time period of functional reliability, that is, the service life of the brake pads, is therefore increased.

Furthermore, the possibility exists of utilizing the signals for controlling an electronic braking system (EBS), preferably in the course of a signal analysis.

A system for implementing the method is constructed such that a transmitter emitting reflectable signals and a receiver receiving the reflected signals are provided on a disc brake, or on components adjacent thereto, which transmitter and receiver are in an operative connection with an electronic analyzing system.

The transmitter, as well as the receiver, can be stationarily positioned with respect to the functional parts to be tested, which parts change in their position as a result of wear or disturbances, so that a relative distance change occurs in the event of wear or of a disturbance. However, it is also contemplated that the transmitter and the receiver are fastened to supporting parts, whose position can be changed, for example, to brake pad supports.

According to advantageous further developments of the invention, it is provided that the transmitter and the receiver, respectively, are constructed as an ultrasonic or laser transmitter and as an ultrasonic or laser receiver, respectively.

Furthermore, the transmitter and the receiver can be provided as a constructional unit, which results in particularly simple mounting and demounting. In addition, the constructional combination of the transmitter and the receiver permits a particularly effective protection against external influences, such as dirt and the like.

The constructional unit can be placed inside the disc brake as well as outside.

Additional advantageous developments of the invention are described and claimed herein.

### BRIEF DESCRIPTION OF THE DRAWINGS

In the following, embodiments of the invention are described in conjunction with the attached drawings.

FIG. 1 is a schematic longitudinal sectional view of a pneumatic disc brake;

FIG. 2 is a schematic top view of the disc brake of FIG. 1;

FIG. 3 is a lateral view of a partial cutout of the disc brake;

FIG. 4 is a view of the embodiment according to FIG. 3 in a special construction;

FIG. 5 is a view of another embodiment of the invention in a schematically illustrated detail as a lateral view;

FIGS. 6 and 7 are views of the embodiment according to FIG. 5, in each case as a special construction in a schematically illustrated partial lateral view.

### DETAILED DESCRIPTION OF THE DRAWINGS

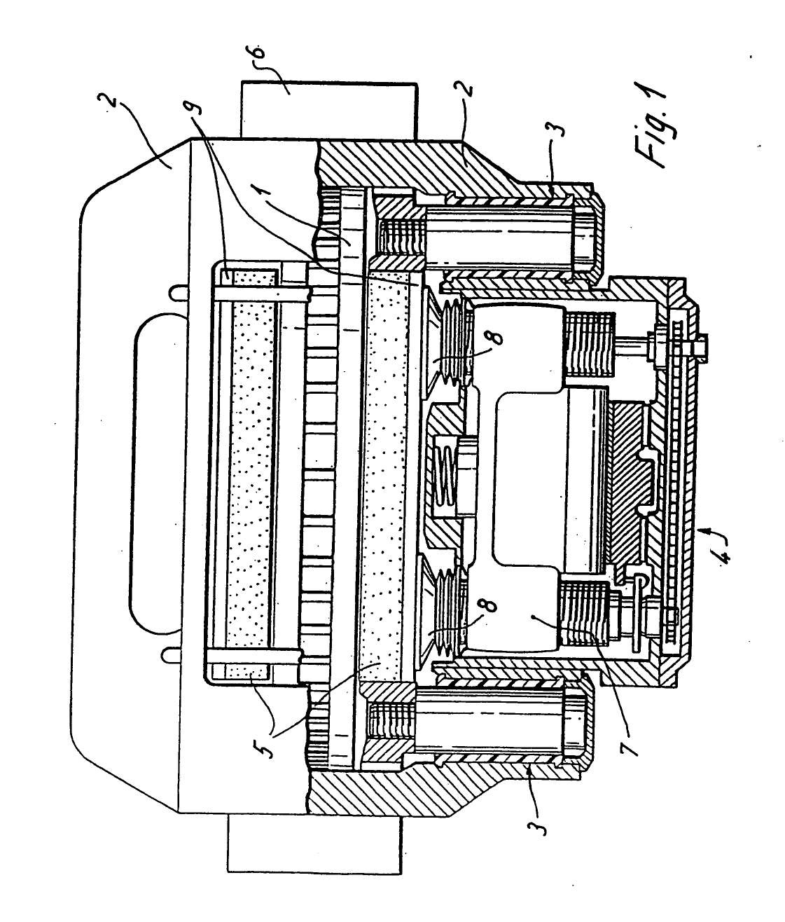

FIG. 1 illustrates the basic structure of a disc brake of the above-mentioned type, which disc brake has a brake disc 1 fastened to an axles (which is not shown) of a commercial vehicle. The brake disc 1 is straddled by a caliper 2 which, by means of fastening elements 3, is axially displaceably fixed relative to the brake disc 1 in a brake anchor plate 6 of the commercial vehicle.

As further illustrated in FIG. 1, the brake disc 1 can be operatively connected with brake pads 5, for the purpose of which, the brake pads 5 are pressed against the brake disc 1 during braking. The brake pads 5 are each fastened on a brake pad support plate 9.

A brake application device provided with reference number 4 has two parallel pressure pieces 8, which pressure pieces 8 rest against one of the two brake pads 5.

The function of the brake application device is known, for example, from European Patent document EP 566 006, so that a corresponding description is not necessary.

The two pressure pieces 8 are mutually connected by a bridge 7, whose position can be changed. The bridge 7 extends inside the caliper 2 essentially parallel to the axis of rotation of the brake disc 1 and is displaceably disposed in this plane.

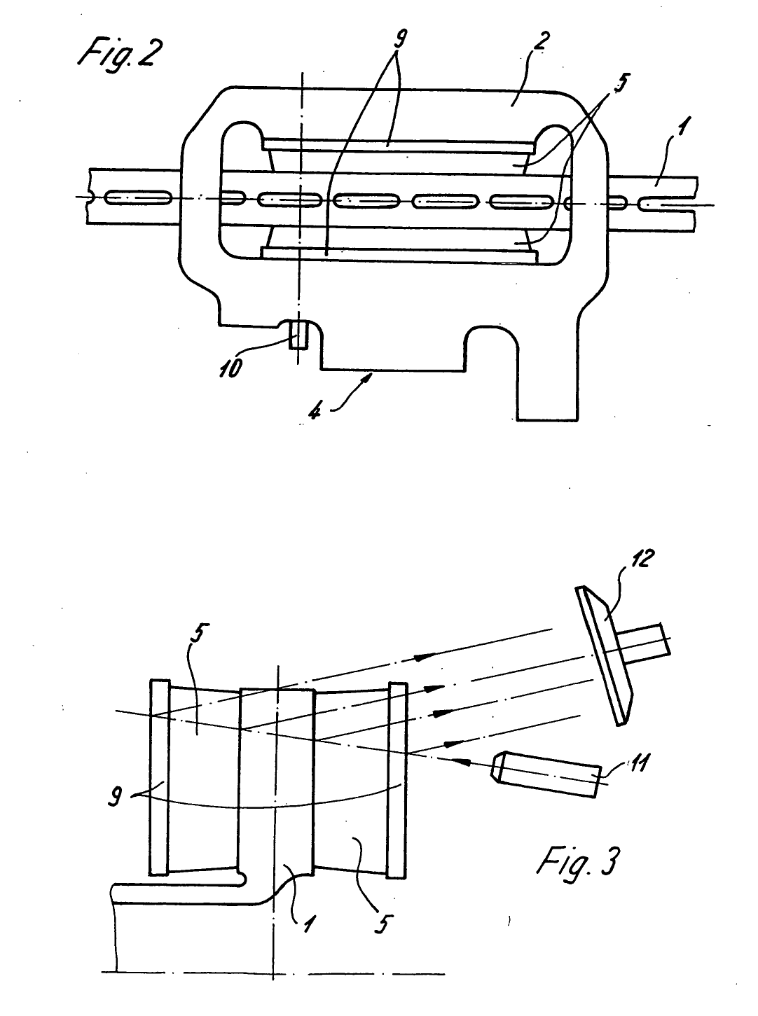

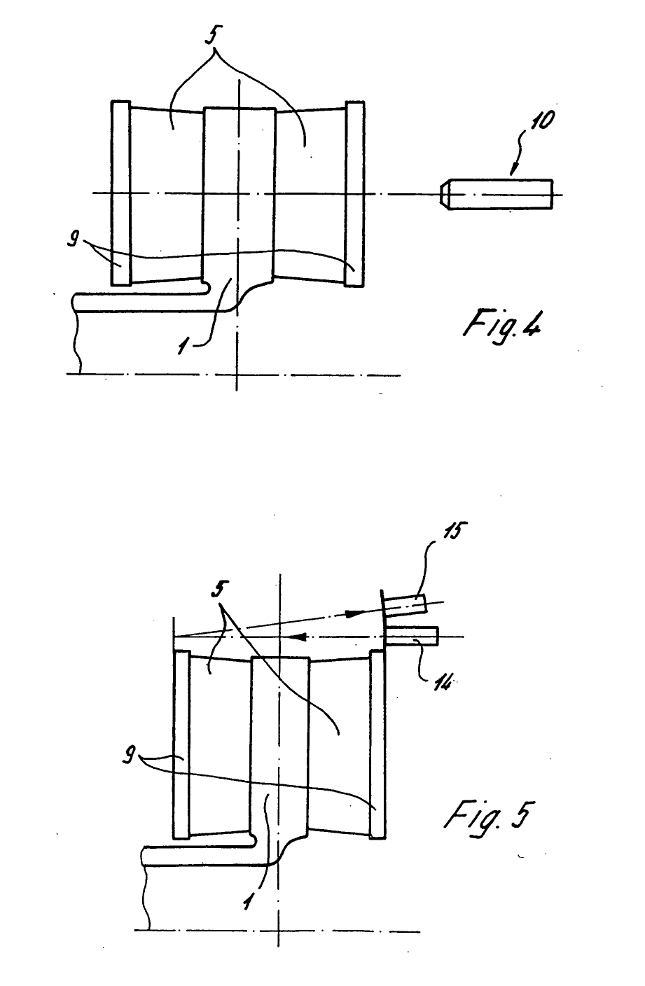

FIG. 2 shows a transmitter/receiver unit 10 connected to the disc brake. According to FIGS. 3 and 4, the unit 10 may consist of an ultrasonic transmitter 11 and an ultrasonic receiver 12, these being provided in FIG. 3 as separate components, while, corresponding to FIG. 4, they form a constructional unit.

The transmitter/receiver unit 10 (or the ultrasonic transmitter 11 and the ultrasonic receiver 12) are stationarily installed with respect to the brake disc 1 and the brake pad support plates 9.

During operation, the ultrasonic transmitter 11 emits a reflectable signal, which is partially reflected by the partition gaps between the brake pads 5 and the brake disc 1. The reflected signals are received by the ultrasonic receiver 12. Because of the different paths, the propagation times of the individually reflected beams change corresponding to a wear-caused reduction of the brake pads 5 and/or of the brake disc 1.

By using an electronic analyzing system, which is in an operative connection with the transmitter/receiver unit 10, in conjunction with the determined parameters, a wear of each brake pad 5 and of the brake disc 1 can be determined by an actual and desired value comparison.

The embodiment illustrated in FIG. 4, in which the ultrasonic transmitter 11 and the ultrasonic receiver 12 are combined in the above-mentioned transmitter/receiver unit 10, represents a particularly advantageous construction, specifically with respect to a constructional accommodation which permits a simple and cost-effective mounting but also such a manufacturing.

The selected placement of the transmitter/receiver unit 10 also permits the checking of movement sequences of selected interior parts, for example, of the bridge 7 illustrated in FIG. 1.

By using the transmitter/receiver unit 10, the position of the bridge 7 before and after an application is measured at a defined actuating force, the air pressure in the pressure cylinder being used as a parameter.

The displacement path of the bridge 7 is composed of the release play and of the elastic deformation of the brake components, mainly of the caliper 2 and of the brake pads 5. The elastic deformation takes place linearly proportional to the actuating force, so that it can be precisely determined by a pressure measurement.

When the movement path of the bridge 7 during actuation of the brake at a defined force exceeds or falls below the defined values, this is the result of a release play which is too large or too small, so that disturbances of the adjusting function are detected in time and can be eliminated.

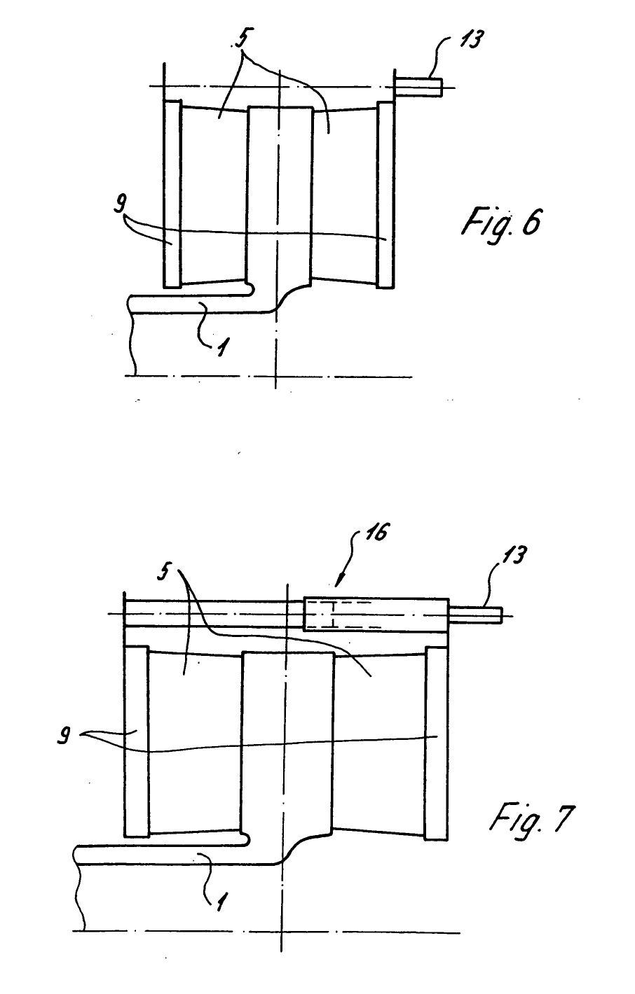

For monitoring a cumulative wear, at which the wear of the two brake pads 5 and of the brake disc 1 is determined as a whole, in the embodiment illustrated in FIGS. 5 to 7, a transmitter/receiver unit 13 is provided which consists of a laser transmitter 14 and of a laser receiver 15. The unit is fastened to a brake pad support plate 9, whose position can be changed. In this case, the laser transmitter 14 and the laser receiver 15 can definitely also be constructed separately, thus, not as a unit.

For determining or monitoring the wear, a path measurement to the opposite brake pad support plate 9 is carried out, corresponding information being supplied when a minimum route has been reached, which minimum route is defined as the desired value. An electronic analyzing system is also provided for analyzing the measured values.

FIG. 7 shows an embodiment in which the transmitter/receiver unit 13 is disposed in a tube-shaped casing 16, which has a telescopic construction and is defined in its length by the length of the path to be determined. This casing shields the transmitter/receiver unit from outside influences and thus provides optimal protection for its operation.

### Table of Reference Numbers

1 Brake disc
2 caliper
3 fastening element
4 application device
5 brake pad
6 brake anchor plate
7 bridge
8 pressure piece
9 pad support
10 transmitter/receiver unit
11 ultrasonic transmitter
12 ultrasonic receiver

1-15. (canceled)

16. A method for testing functional reliability of pneumatically or electromechanically operable disc brake parts, which parts are at least one of subject to wear and functional, and whose position is changeable, the method comprising the acts of:
transmitting reflectable signals from a transmitter to the disc brake part to be tested;
receiving reflected signals from the part to be tested by a receiver;
comparing determined actual values based on the received reflected signals with predefined values; and
analyzing results of the comparison as part of the testing.

17. The method according to claim 16, wherein ultrasonic signals are transmitted and received.

18. The method according to claim 16, wherein laser beam signals are transmitted and received.

19. The method according to claim 16, wherein the reflected signals are those reflected by surfaces of the disc brake part which bound partition gaps and are at least one of subject to wear and functional.

20. The method according to claim 16, wherein the acts of transmitting and receiving further comprise the acts of transmitting the reflectable signals onto a bridge of a brake application device and receiving reflected signals from the bridge of the brake application device.

21. The method according to claim 16, wherein the method determines an amount of wear of brake pads that form the disc brake parts subject to wear.

22. The method according to claim 16, wherein the method determines wear of a brake disc that forms a disc brake part subject to wear.

23. A system for testing functional reliability of pneumatically or electromechanically operable disc brake parts, which parts are at least one of subject to wear and functional, and whose position is changeable, the system comprising:
a transmitter that emits the reflectable signals;
a receiver that receives the reflected signals; and
wherein the transmitter and receiver are arranged on one of a disc brake and a component adjacent to the disc brake, said transmitter and receiver being operatively coupled with an electronic analyzing system.

24. The system according to claim 23, wherein at least one of the transmitter and the receiver are arranged stationarily with respect to the disc brake parts.

25. The system according to claim 23, wherein at least one of the transmitter and the receiver are arranged on components of the disc brake whose position is changeable.

26. The system according to claim 23, wherein the transmitter is an ultrasonic transmitter and the receiver is an ultrasonic receiver.

27. The system according to claim 23, wherein the transmitter is a laser transmitter and the receiver is a laser receiver.

28. The system according to claim 23, wherein the transmitter and the receiver are combined into a functional transmitter/receiver unit.

29. The system according to claim 28, further comprising a casing in which the functional transmitter/receiver unit is housed.

30. The system according to claim 29, wherein the casing has a telescopic construction.
